(19) United States
(12) Patent Application Publication
(10) Pub. No.: US 2025/0317734 A1
(43) Pub. Date: Oct. 9, 2025

(54) Methods and Systems for In-Band Sign Up to a Wireless Network

(71) Applicant: Google LLC, Mountain View, CA (US)

(72) Inventor: Hai Shalom, Mountain View, CA (US)

(21) Appl. No.: 18/864,624

(22) PCT Filed: May 25, 2022
(86) PCT No.: PCT/US2022/072551

§ 371 Date: Nov. 11, 2024

(51) Int. Cl. H04W 12/069; H04W 76/10

(52) U.S. Cl. CPC H04W 12/069; H04W 76/10

(57) ABSTRACT

An example method includes determining, by a client computing device, that a wireless access point (WAP) supports an in-band secure access protocol to connect to a wireless network hosted by a server, where the protocol involves establishing an initial network connection to exchange subscription data. The method includes receiving, from the WAP, a temporary login credential and an authentication protocol for the server. The method includes utilizing the temporary login credential and the authentication protocol to establish the initial network connection. The method includes exchanging the subscription data with the server over the initial network connection. The method includes completing the protocol by downloading, from the WAP and over the initial network connection, a subscription file. The subscription file enables the client computing device to establish an encrypted and trusted network connection over the wireless network.

### BACKGROUND

The present disclosure generally relates to providing network access, and in particular, to providing secured wireless local area network access.

Wireless local area networks have greatly improved the manner in which users may access information on the internet. Accessing a wireless local area network may require a user to select the service set identifier (SSID) of a wireless access point within the wireless local area network. In addition, the user may need to enter a passphrase (e.g., Wireless-Fidelity (Wi-Fi) protected passphrase) of the wireless access point or use other types of credentials to establish a wireless network connection.

### SUMMARY

The present disclosure generally relates to onboarding mobile computing devices to wireless networks. Example wireless networks include Wi-Fi Enterprise and PASSPOINT® (Passpoint) networks. As a general matter, when a Wi-Fi enabled device arrives in an environment with a public Enterprise or Passpoint network that the device has not previously connected to, an SSID for the network appears on a Wi-Fi picker of the device, accompanied by a lock icon. Tapping on the SSID to connect to the network can open a menu with complex configuration requirements that a user has to complete. A typical user may not be able to complete the configuration process due to a lack of available technical information (e.g., a server certificate, temporary credentials, and so forth), and/or a complexity of the requirements. As a result, the user may instead opt to connect over an open and unsecured network, thereby exposing the device and user data to hostile activities.

In a first aspect, a computer-implemented method is provided. The method includes determining, by a client computing device, that a wireless access point (WAP) supports an in-band secure access protocol to connect to a wireless network hosted by a server, wherein the in-band secure access protocol comprises establishing an initial network connection to exchange subscription data to connect to the wireless network. The method also includes receiving, by the client computing device from the WAP, a temporary login credential and an authentication protocol for the server. The method further includes utilizing the temporary login credential and the authentication protocol to establish the initial network connection with the WAP. The method further includes exchanging the subscription data with the server over the initial network connection. The method also includes completing the in-band secure access protocol by downloading, from the WAP and over the initial network connection, a subscription file, wherein the subscription file is based on the subscription data, and wherein the subscription file enables the client computing device to establish an encrypted and trusted network connection over the wireless network.

In a second aspect, a system is provided. The system may include one or more processors. The system may also include data storage, where the data storage has stored thereon computer-executable instructions that, when executed by the one or more processors, cause the system to carry out operations. The operations may include determining, by a client computing device, that a wireless access point (WAP) supports an in-band secure access protocol to connect to a wireless network hosted by a server, wherein the in-band secure access protocol comprises establishing an initial network connection to exchange subscription data to connect to the wireless network. The operations may also include receiving, by the client computing device from the WAP, a temporary login credential and an authentication protocol for the server. The operations may further include utilizing the temporary login credential and the authentication protocol to establish the initial network connection with the WAP. The operations may further include exchanging the subscription data with the server over the initial network connection. The operations may also include completing the in-band secure access protocol by downloading, from the WAP and over the initial network connection, a subscription file, wherein the subscription file is based on the subscription data, and wherein the subscription file enables the client computing device to establish an encrypted and trusted network connection over the wireless network.

In a third aspect, a device is provided. The device includes one or more processors operable to perform operations. The operations may include determining, by a client computing device, that a wireless access point (WAP) supports an in-band secure access protocol to connect to a wireless network hosted by a server, wherein the in-band secure access protocol comprises establishing an initial network connection to exchange subscription data to connect to the wireless network. The operations may also include receiving, by the client computing device from the WAP, a temporary login credential and an authentication protocol for the server. The operations may further include utilizing the temporary login credential and the authentication protocol to establish the initial network connection with the WAP. The operations may further include exchanging the subscription data with the server over the initial network connection. The operations may also include completing the in-band secure access protocol by downloading, from the WAP and over the initial network connection, a subscription file, wherein the subscription file is based on the subscription data, and wherein the subscription file enables the client computing device to establish an encrypted and trusted network connection over the wireless network.

In a fourth aspect, an article of manufacture is provided. The article of manufacture may include a non-transitory computer-readable medium having stored thereon program instructions that, upon execution by one or more processors of a computing device, cause the computing device to carry out operations. The operations may include determining, by a client computing device, that a wireless access point (WAP) supports an in-band secure access protocol to connect to a wireless network hosted by a server, wherein the in-band secure access protocol comprises establishing an initial network connection to exchange subscription data to connect to the wireless network. The operations may also include receiving, by the client computing device from the WAP, a temporary login credential and an authentication protocol for the server. The operations may further include utilizing the temporary login credential and the authentication protocol to establish the initial network connection with the WAP. The operations may further include exchanging the subscription data with the server over the initial network connection. The operations may also include completing the in-band secure access protocol by downloading, from the WAP and over the initial network connection, a subscription file, wherein the subscription file is based on the subscription data, and wherein the subscription file enables the client computing device to establish an encrypted and trusted network connection over the wireless network.

In a fifth aspect, a computer-implemented method is provided. The method may include broadcasting, by a wireless access point (WAP), that the WAP supports an in-band secure access protocol to connect to a wireless network hosted by a server, wherein the in-band secure access protocol comprises establishing an initial network connection to exchange subscription data to connect to the wireless network. The method may further include sending, by the WAP to a client computing device, a temporary login credential and an authentication protocol for the server. The method may also include enabling, by the WAP, the client computing device to utilize the temporary login credential and the authentication protocol to establish the initial network connection with the WAP. The method may additionally include enabling the exchange of the subscription data between the client computing device and the server over the initial network connection. The method may also include completing the in-band secure access protocol by providing, over the initial network connection, a subscription file for download by the client computing device, wherein the subscription file is based on the subscription data, and wherein the subscription file enables the client computing device to establish an encrypted and trusted network connection over the wireless network.

In a sixth aspect, a system is provided. The system may include one or more processors. The system may also include data storage, where the data storage has stored thereon computer-executable instructions that, when executed by the one or more processors, cause the system to carry out operations. The operations may include broadcasting, by a wireless access point (WAP), that the WAP supports an in-band secure access protocol to connect to a wireless network hosted by a server, wherein the in-band secure access protocol comprises establishing an initial network connection to exchange subscription data to connect to the wireless network. The operations may further include sending, by the WAP to a client computing device, a temporary login credential and an authentication protocol for the server. The operations may also include enabling, by the WAP, the client computing device to utilize the temporary login credential and the authentication protocol to establish the initial network connection with the WAP. The operations may additionally include enabling the exchange of the subscription data between the client computing device and the server over the initial network connection. The operations may also include completing the in-band secure access protocol by providing, over the initial network connection, a subscription file for download by the client computing device, wherein the subscription file is based on the subscription data, and wherein the subscription file enables the client computing device to establish an encrypted and trusted network connection over the wireless network.

In a seventh aspect, a device is provided. The device includes one or more processors operable to perform operations. The operations may include broadcasting, by a wireless access point (WAP), that the WAP supports an in-band secure access protocol to connect to a wireless network hosted by a server, wherein the in-band secure access protocol comprises establishing an initial network connection to exchange subscription data to connect to the wireless network. The operations may further include sending, by the WAP to a client computing device, a temporary login credential and an authentication protocol for the server. The operations may also include enabling, by the WAP, the client computing device to utilize the temporary login credential and the authentication protocol to establish the initial network connection with the WAP. The operations may additionally include enabling the exchange of the subscription data between the client computing device and the server over the initial network connection. The operations may also include completing the in-band secure access protocol by providing, over the initial network connection, a subscription file for download by the client computing device, wherein the subscription file is based on the subscription data, and wherein the subscription file enables the client computing device to establish an encrypted and trusted network connection over the wireless network.

In an eighth aspect, an article of manufacture is provided. The article of manufacture may include a non-transitory computer-readable medium having stored thereon program instructions that, upon execution by one or more processors of a computing device, cause the computing device to carry out operations. The operations may include broadcasting, by a wireless access point (WAP), that the WAP supports an in-band secure access protocol to connect to a wireless network hosted by a server, wherein the in-band secure access protocol comprises establishing an initial network connection to exchange subscription data to connect to the wireless network. The operations may further include sending, by the WAP to a client computing device, a temporary login credential and an authentication protocol for the server. The operations may also include enabling, by the WAP, the client computing device to utilize the temporary login credential and the authentication protocol to establish the initial network connection with the WAP. The operations may additionally include enabling the exchange of the subscription data between the client computing device and the server over the initial network connection. The operations may also include completing the in-band secure access protocol by providing, over the initial network connection, a subscription file for download by the client computing device, wherein the subscription file is based on the subscription data, and wherein the subscription file enables the client computing device to establish an encrypted and trusted network connection over the wireless network.

In a ninth aspect, a system is provided. The system may include a wireless access point (WAP) configured to broadcast that the WAP supports an in-band secure access protocol to connect to a wireless network hosted by a server, wherein the in-band secure access protocol comprises establishing an initial network connection to exchange subscription data to connect to the wireless network. The system may also include a client computing device that includes one or more processors and data storage. The data storage may have stored thereon computer-executable instructions that, when executed by the one or more processors, cause the client computing device to perform operations. The operations may include determining, based on the broadcast, that the WAP supports the in-band secure access protocol. The operations may also include receiving, from the WAP, a temporary login credential and an authentication protocol for the server. The operations may further include utilizing the temporary login credential and the authentication protocol to establish the initial network connection with the WAP. The operations may also include exchanging the subscription data with the server over the initial network connection. The operations may further include completing the in-band secure access protocol by downloading, from the WAP and over the initial network connection, a subscription file, wherein the subscription file is based on the subscription data, and wherein the subscription file enables the client computing device to establish an encrypted and trusted network connection over the wireless network.

Other aspects, embodiments, and implementations will become apparent to those of ordinary skill in the art by reading the following detailed description, with reference where appropriate to the accompanying drawings.

### BRIEF DESCRIPTION OF THE FIGURES

FIG. 1 depicts an example network environment, in accordance with example embodiments.

FIG. 2 illustrates an example in-bound connection protocol, in accordance with example embodiments.

FIG. 3 illustrates an example client computing device, in accordance with example embodiments.

FIG. 4 illustrates an example wireless access point, in accordance with example embodiments.

FIG. 5 illustrates a method, in accordance with example embodiments.

FIG. 6 illustrates another method, in accordance with example embodiments.

### DETAILED DESCRIPTION

Example methods, devices, and systems are described herein. It should be understood that the words “example” and “exemplary” are used herein to mean “serving as an example, instance, or illustration.” Any embodiment or feature described herein as being an “example” or “exemplary” is not necessarily to be construed as preferred or advantageous over other embodiments or features. Other embodiments can be utilized, and other changes can be made, without departing from the scope of the subject matter presented herein.

Thus, the example embodiments described herein are not meant to be limiting. Aspects of the present disclosure, as generally described herein, and illustrated in the figures, can be arranged, substituted, combined, separated, and designed in a wide variety of different configurations, all of which are contemplated herein.

Further, unless context suggests otherwise, the features illustrated in each of the figures may be used in combination with one another. Thus, the figures should be generally viewed as component aspects of one or more overall embodiments, with the understanding that not all illustrated features are necessary for each embodiment.

### I. Overview

A mobile computing device may need to connect to a secured and authenticated wireless network. For example, the mobile device may be a Wi-Fi only device, and may not be configurable to access a cellular network. Also, for example, the mobile device may be at a location where cellular networks may be unavailable (e.g., an underground location, a remote location, in-flight, and so forth), connecting to the cellular network may be expensive (e.g., a foreign location), and/or a strength of the available cellular network may not be adequate for a desired level of connectivity (e.g., inside a building, not close to a cell tower, and so forth).

Although wireless networks may be available, there may be a high level of complexity to configure a secured and authenticated network access. Consequently, the mobile device may resort to using a network connection that may be unsecured, unauthenticated, and/or unencrypted. This may cause the device to be vulnerable to cyberattacks.

The Wi-Fi Alliance® (WFA) proposed an Online Sign-Up (OSU) protocol that requires dedicated WFA Root certificates which need to be manually acquired from a single vendor, and that require significant investments on both the client and server side. For example, OSU requires an additional open SSID at the venue for the registration, or a parallel server-only authenticated layer 2 Encryption Network (OSEN) to allow client devices to connect for registration.

In some situations, onboarding may be performed offline. For example, client operating systems may support a web based provisioning method where the client device connects to a web site while having an alternative connectivity method (for example, while using the home Wi-Fi before traveling, or a cellular network), and that web site generates an appropriate subscription based on the web browser and OS version of the client device. However, this is not an in-band solution and requires advance preparations. It is also not suitable for a walk-in scenario where a user arrives at a venue and looks for any connectivity.

Existing methods of accessing a wireless network include an access point that advertises, via a beacon, that it supports Enterprise or Passpoint security. A client computing device (e.g., a mobile phone) in a vicinity of the access point may perform a scan and detect all Enterprise and Passpoint networks in the local area.

For the Passpoint networks, the client computing device sends an access network query protocol (ANQP) request to the access point, and in response, the access point provides an ANQP element with additional details about each available network. Such additional details enable a client computing device to determine if a connection can be established with a network.

The client computing device may then use the ANQP element to determine if there is a match with locally (e.g., on-device) saved Enterprise networks and Passpoint subscriptions. Upon a determination that there is a match, the client computing device may automatically connect to the network. However, upon a determination that there is no match, the client computing device is unable to establish a connection, and the client computing device remains disconnected. As such, the client computing device may be unable to access network resources available over the wireless network. This can cause inconvenience, especially for Wi-Fi only devices, and/or at locations where cellular network coverage is negatively impacted or unavailable.

Also, for example, although secured Wi-Fi networks may be available, such networks generally require a registration process over an unsecured network. Accordingly, a user of a client device may have to provide protected data (e.g., name, address, email address, payment information, and so forth) over the unsecured network, thereby making the protected data vulnerable to online threats. Although some portions of the registration process may be secured, this can vary from one wireless access point to another, and also vary from one network to another. Also, for example, a user may not be aware whether the connection is secure or not. In some situations, the user may need to manually configure advanced secure network settings based on information from the wireless access point.

Some network providers make available two or more access points. A first access point may provide an open authentication to enable the client device to download and install subscription data. Subsequently, the client device may use the subscription to establish a secured connection with a trusted server via a second access point. However, it utilizes two access points with two different bands and contributes to wasted air time. Also, for example, providing this service may entail higher maintenance and management costs for network providers as two or more access points are needed to advertise different SSIDs, have different functionalities, and so forth. On the client device side, these different connections with different access points may utilize higher power resources, have higher network latency, and/or cause a delay in establishing the network connection.

Accordingly, there is a need for a protocol that enables an in-band authentication process to connect to a secured and authenticated wireless network, while sharing protected data over a secured network. For example, when a Wi-Fi enabled client device arrives at an environment with a public Enterprise or Passpoint network that the client device does not recognize, and/or has not connected to in the past, the client device may be able to engage the user to take an action to sign up, and join the network by following an in-band sign-up protocol.

Such a protocol may be advantageous to users by providing them with secure and reliable network connections with trusted servers. Since many users may not connect to a secured network in the absence of such a protocol, the protocol may also open monetization opportunities for network providers.

### Example Data Network

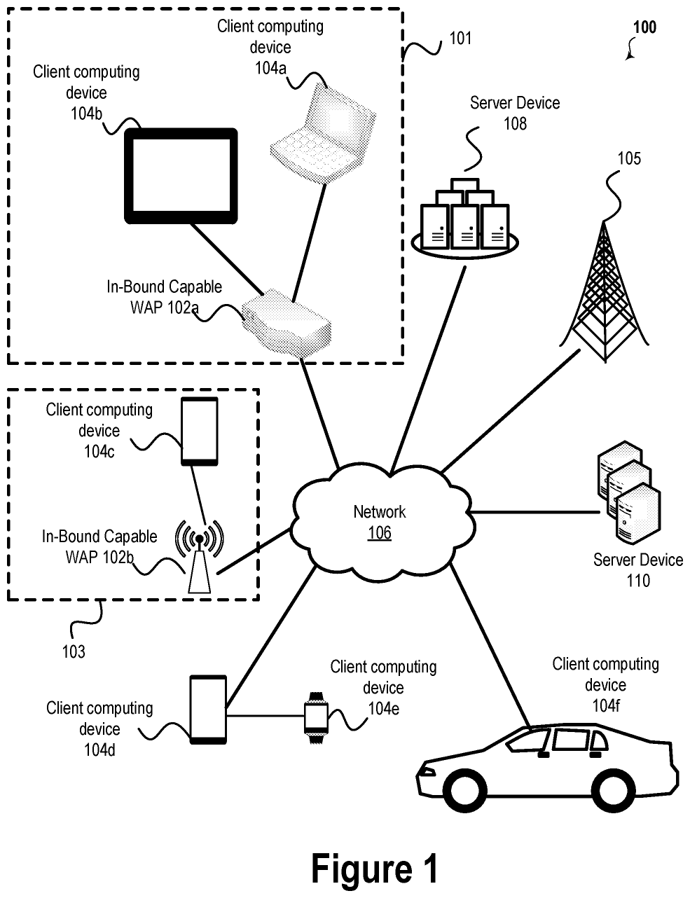

FIG. 1 depicts an example network environment 100, in accordance with example embodiments. Network environment 100 includes server devices 108, 110 that are configured to communicate, via network 106, with client computing devices 104a, 104b, 104c, 104d, 104e, 104f. Network 106 may correspond to a local area network (LAN), a wide area network (WAN), a WLAN, a WWAN, a corporate intranet, the public Internet, or any other type of network configured to provide a communications path between networked computing devices. Network 106 may also correspond to a combination of one or more LANs, WANs, corporate intranets, and/or the public Internet. Network 106 can include, but is not limited to, any one or more of the following network topologies, including a bus network, a star network, a ring network, a mesh network, a star-bus network, tree or hierarchical network, and the like.

Although FIG. 1 only shows six client computing devices (e.g., programmable devices), a distributed application architecture may serve tens, hundreds, or thousands of programmable devices. Moreover, client computing devices 104a-104f (or any additional programmable devices) may be any sort of computing device, such as a mobile computing device, desktop computer, wearable computing device, head-mountable device (HMD), network terminal, a mobile computing device, a gaming console, an intelligent assistant, a network appliance, a camera, a cellular phone, a smart phone, and so on.

In some examples, such as illustrated by client computing devices 104d, 104f, client computing devices can be directly connected to network 106. In other examples, such as illustrated by client computing devices 104a, 104b, 104c, 104e, client computing devices can be indirectly connected to network 106 via an associated computing device. For example, client computing devices 104a, 104b can be indirectly connected to network 106 via an access point such as WAP 102a. As another example, client computing device 104c can be indirectly connected to network 106 via an access point such as WAP 102b. Also, for example, client computing device 104e client computing device via client computing device 104d. In this example, client computing device 104d can act as an associated computing device to pass electronic communications between client computing device 104e and network 106. In other examples, such as illustrated by client computing device 104f, a client computing device can be part of and/or inside a vehicle, such as a car, a truck, a bus, a boat or ship, an airplane, etc. In other examples not shown in FIG. 1, a client computing device can be both directly and indirectly connected to network 106.

In some examples, network environment 100 includes wireless local area networks (WLAN) 101 and 103 and service tower 105. WLAN 101 can include wireless access point (WAP) 102a and client computing devices 104a, 104b, and WLAN 103 can include WAP 102b and client computing device 104c. Client computing devices 104a, 104b, and 104c can allow a user to access a wireless local area network, such as WLAN 101 or 103, by authenticating credentials of the user with an authentication service, such as provided by a wireless access point, such as WAP 102a or 102b.

Server devices 108, 110 can be configured to perform one or more services, as requested by client computing devices 104a-104f. For example, server device 108 and/or 110 can provide content to client computing devices 104a-104f. The content can include, but is not limited to, web pages, hypertext, scripts, binary data such as compiled software, images, audio, and/or video. The content can include compressed and/or uncompressed content. The content can be encrypted and/or unencrypted. Other types of content are possible as well.

As another example, server device 108 and/or 110 can provide client computing devices 104a-104f with access to software for database, search, computation, graphical, audio, video, World Wide Web/Internet utilization, and/or other functions. Many other examples of server devices are possible as well.

Server device 108 can include one or more computing devices and one or more computer-readable storage devices (e.g., data stores). Server device 108 may be a system or device having a processor, a memory, and communications capability for providing content and/or services to client devices. In some example aspects, server device 108 can be a single computing device, for example, a computer server. In other embodiments, server device 108 can represent more than one computing device working together to perform the actions of a server computer (e.g., cloud computing). Further, server device 108 can represent various forms of servers including, but not limited to an application server, a proxy server, a network server, an authentication server, an electronic messaging server, a content server, etc., accessible to the client computing devices 104a-104f. In some aspects, server device 108 may be an authentication server that provides user authentication services for wireless local area network access.

Server device 110 may be a system or device having a processor, a memory, and communications capability for providing content and/or services to client devices. In some example aspects, server device 110 can be a single computing device, for example, a computer server. In other embodiments, server device 110 can represent more than one computing device working together to perform the actions of a server computer (e.g., cloud computing). Server device 108 and/or 110 may be implemented as a single server or across multiple servers. Server device 110 may perform various functionalities and/or storage capabilities described herein either alone or in combination with server device 108. Each of server devices 108 and/or 110 may host various services, including cloud-based services. A cloud-based service may require authentication of a user account for access via a cloud-based application, such as a web-based personal portal or a web-based email application.

For example, a user may interact with content and/or services hosted by server device 108, through a client application installed at client computing device 104a, such as a web browser application. Communication between client computing device 104a and server device 108 may be facilitated through WLAN 101 and network 106 via WAP 102a.

Client computing devices 104a-104f may communicate wirelessly with service tower 105 through a local communication interface, which may include digital signal processing circuitry where necessary. The communication interface may provide for communications under various modes or protocols, for example, Long Term Evolution (LTE) voice and data, Global System for Mobile communication (GSM) voice calls, Short Message Service (SMS), Enhanced Messaging Service (EMS), or Multimedia Messaging Service (MMS) messaging, Code Division Multiple Access (CDMA), Time Division Multiple Access (TDMA), Personal Digital Cellular (PDC), Wideband Code Division Multiple Access (WCDMA), CDMA3000, or General Packet Radio System (GPRS), among others.

Communication between clients (e.g., wireless client devices 112, 114, 122, and/or 124) and servers (e.g., server 130 and/or servers 140) can occur via a virtual private network (VPN), Secure Shell (SSH) tunnel, Transport Layer Security (TLS) tunnel, Extensible Authentication Protocol (EAP)-TLS based tunnel, tunnel on top of GAS/ANQR or other secure network connection. In some examples, an authentication protocol may include a server authentication protocol and a phase-2 protocol. For example, the server authentication protocol may include an extensible authentication protocol (EAP) with a secure sockets layer (SSL) around diameter type length values (TLVs), and the phase-2 protocol comprises a challenge handshake authentication protocol. Also, for example, the server authentication protocol may include an extensible authentication protocol (EAP) with a secure sockets layer (SSL) around the EAP, and the phase-2 protocol comprises a generic token card (GTC).

WLANs 101 or 103 can include, but are not limited to, a computer network that covers a limited geographic area (e.g., an airport, a cafe, a train station, an office, a school, a university, and so forth). Client computing devices 104a-104f may associate with WAP 102a or WAP 102b using wireless fidelity (Wi-Fi) standards (e.g., IEEE 802.11). In some examples, Wi-Fi access standards may include Passpoint or Enterprise networks. Protected access may be provided over these networks using various security protocols, such as, WPA3™, WPA3-Personal, WPA3-Enterprise, and so forth.

As a general matter, a Wi-Fi standard can include multiple frequency bands (e.g., 2.4 GigaHertz (GHz), 5 GHz, etc.). For example, a 2.4 GHz band can include 11 distinct channels associated with 11 carrier frequencies. A wireless access point, such as WAP 102a or WAP 102b can scan these frequencies to detect a presence of a client computing device (e.g., client computing devices 104a-104f) by determining whether a client computing device is transmitting on a particular frequency. In some examples, WAP 102a or WAP 102b may transmit a probe request on a particular frequency to seek a response from a client computing device.

For each client computing device detected by WAP 102a or WAP 102b, the wireless access point may attempt to obtain an associated identifier, such as a service set identifier (SSID), basic service set identifier (BSSID), and/or media access control (MAC) address. Other identifiers, such as serial numbers or Internet Protocol (IP) addresses may be used instead of, or as well as, these identifiers.

### II. Example in-Band Access Protocols

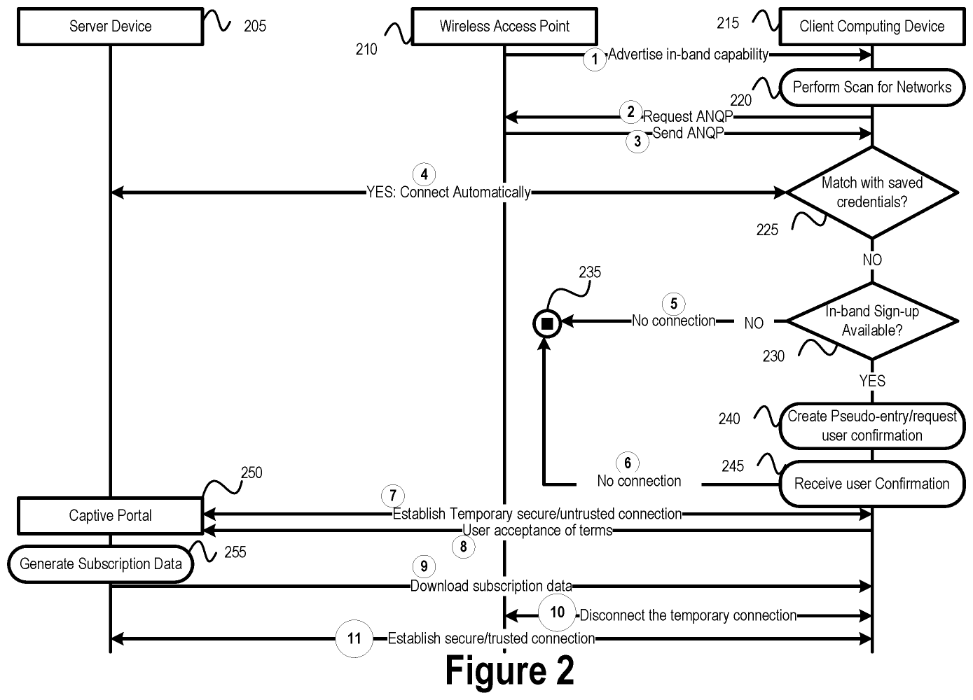

FIG. 2 illustrates an example, in-band connection protocol, in accordance with example embodiments. As described herein, an in-band sign up framework for a Wi-Fi enabled client computing device 215 (e.g. a mobile phone) may enable a user to join a network environment with a public Enterprise or Passpoint Wi-Fi network that client computing device 215 is not subscribed to, or has not connected to in the past.

At step 1, wireless access point (WAP) 210 may be configured to support in-band sign up. In some embodiments, WAP 210 may broadcast that WAP 210 supports an in-band secure access protocol to connect to a wireless network hosted by server device 205. The in-band secure access protocol includes establishing an initial network connection to exchange subscription data to connect to the wireless network. In some embodiments, WAP 210 may broadcast a beacon including a capability bit indicating the support for the in-band secure access protocol.

At 220, client computing device 215 may scan and detect the Enterprise and/or Passpoint networks. For example, client computing device 215 may arrive at a networking environment, and may scan and detect one or more networks supported by WAP 210. For example, WAP 210 may periodically advertise capabilities, such as a name, types of networks, associated security protocols, and so forth. For example, a beacon broadcast by WAP 210 may include one bit that indicates that WAP 210 is a Passpoint network, and/or another bit that indicates that WAP 210 supports an in-band access protocol.

In existing sign-up protocols, an ANQP is utilized to enable client computing device 215 to query WAP 210 prior to establishing a connection. Responses to such an ANQP query may enable client computing device 215 to decide whether to connect to WAP 210 or not. Exchanging an ANQP element is a standard process for Passpoint clients to query WAP 210 about supported features, capabilities, and so forth.

As illustrated, at step 2, client computing device 215 may request an ANQP element from WAP 210, and at step 3, WAP 210 may send an ANQP element responsive to the received query. As described previously, the ANQP protocol is used to match client credentials to networks. However, the existing ANQP element would need to be additionally configured to include information that can enable in-band secure access. For example, the ANQP element may be configured to include a domain name of server device 205 associated with a wireless network supported by WAP 210. Also, for example, the ANQP element may be configured to include a root certificate authority (Root CA certificate) configured to sign a server certificate, or a hash of a globally trusted Root CA certificate configured for web browsing. As another example, the ANQP element may be configured to include temporary login credentials (e.g., a temporary username and password).

In some embodiments, the ANQP element may be configured to include a preferred server authentication method and a phase-2 method. In some embodiments, the server authentication protocol may include an extensible authentication protocol (EAP) with a secure sockets layer (SSL) around diameter type length values (TLVs), and the phase-2 protocol comprises a challenge handshake authentication protocol. In some embodiments, the server authentication protocol may include an extensible authentication protocol (EAP) with a secure sockets layer (SSL) around the EAP, and the phase-2 protocol comprises a generic token card (GTC). In general, the ANQP element is not encrypted, and is wirelessly unicasted to each computing device in the network environment of WAP 210.

At 225, client computing device 215 may determine whether the data in the ANQP element matches one or more saved credentials at client computing device 215. Upon a determination that the data in the ANQP element matches a saved credential, at 4, client computing device 215 may connect automatically by utilizing the saved credentials. For example, when client computing device 215 determines that there is a match in the information received in the ANQP element, with local Enterprise saved networks and/or Passpoint subscriptions, client computing device 215 may automatically connect to the network with the saved credentials.

Upon a determination that the data in the ANQP element does not match the one or more saved credentials, at 230, client computing device 215 may determine whether WAP 210 supports an in-band secure access protocol to connect to a wireless network hosted by server device 205.

In some embodiments, client computing device 215 may make such determination based on a beacon broadcast by WAP 210. In some embodiments, when WAP 210 supports the in-band secure access protocol, the ANQP element may be enhanced to indicate this information. For example, WAP 210 may be configured to include a new ANQP element that may convey the information, including the server domain name, temporary username and password, an authentication method, and/or a list of supported authentication methods. Accordingly, when requested by client computing device 215, WAP 210 may include a new ANQP element about the in-band secure access protocol.

Upon a determination that WAP 210 does not support an in-band secure access protocol, at 5, client computing device 215 is unable to establish a connection with WAP 210, and the connection process is automatically terminated at 235. As an in-band secure access protocol is not currently available, existing client computing devices are not capable of determining whether WAP 210 supports an in-band secure access protocol. Accordingly, in current protocols, the process of connecting to a network flows from 225 to 235. In some embodiments, even if a connection protocol is available, a user may have to enter technical specifications about the network. Also, for example, the user may have to provide protected data such as a name, financial information, telephone number, address, and so forth, over an unsecured network, to obtain subscription data from server device 205. Accordingly, what follows enables a seamless and automatic connection protocol whereby protected data can be provided over a secured interface.

Upon a determination that WAP 210 supports an in-band secure access protocol, client computing device 215 may provide, by a display of client computing device 215, a temporary identifier indicative of the wireless network, and an associated user interface element to receive the user confirmation. For example, at 240, client computing device 215 may generate a pseudo entry (e.g., a temporary friendly name acquired via ANQP for the network) in a Wi-Fi picker of client computing device 215. A Wi-Fi picker may generally refer to a display that lists names (e.g., SSIDs and Passpoint friendly names) for available networks in a network. Generally, a user is able to select (e.g., tap) a name on the list, and client computing device 215 attempts to connect to the selected network.

In some embodiments, at 240, client computing device 215 may display a user selectable virtual object asking the user if they would like to join the wireless network. For example, client computing device 215 may generate a pseudo entry in the Wi-Fi picker that would include a network friendly name (e.g., based on the standard ANQP response), and a message below the entry that may indicate “Tap to sign-up”. Client computing device 215 does not attempt to connect automatically, and instead may rely on receiving affirmative user acknowledgement to initiate the sign-up process.

In some embodiments, client computing device 215 may not receive the user confirmation to join the wireless network. For example, the user may ignore the request to join the network for a threshold amount of time. Also, for example, a user policy profile may indicate that the user may not be allowed to join the network. In some embodiments, the user may affirmatively indicate that they do not wish to join the network. Accordingly, at 6, no connection is established, and the connection process terminates at 235. Also, for example, the user policy profile may indicate that the user will not connect to a wireless network that supports the in-band sign-up protocol. Accordingly, client computing device 215 may not initiate the in-band access protocol, without a need for contemporaneous user input.

In some embodiments, client computing device 215 may receive user confirmation to join the wireless network. Accordingly, at 7, client computing device 215 may establish an initial network connection (e.g., a temporary secured but untrusted connection) with WAP 210, and/or server device 205. For example, client computing device 215 may utilize the temporary login credential and the authentication protocol to establish the initial network connection with the WAP.

In some embodiments, upon receiving the user's acknowledgment to start the sign-up process (e.g., the user taps to proceed), client computing device 215 may utilize the ANQP element to generate a temporary extensible authentication protocol (EAP) configuration including: (i) a Service Set Identifier (SSID) of the wireless access point, (ii) the authentication protocol, (iii) a server certificate, (iv) a server domain name, and (v) the temporary login credential. Such embodiments also include utilizing the temporary EAP configuration to establish the initial network connection.

In some embodiments, temporary username and password may be automatically generated by client computing device 215. In some embodiments, WAP 210 may provide the temporary username and password. Also, for example, the temporary username and password may be a standard publicly available password that can be used when a new client device connects to WAP 210. Use of such a temporary credential may indicate to WAP 210 and/or server device 205 that the user may be a non-authenticated, untrusted user attempting to sign-in to the network.

In some embodiments, subsequent to receiving user confirmation at 245, client computing device 215 may be unable to establish the initial network connection. In such embodiments, at 6, no connection is established and the process terminates at 235. Also, for example, client computing device 215 may add the network to a “block” list of networks that cannot be connected to. The network may be included in such a list for an implementation specific time. Also, for example, client computing device 215 may notify the user that an attempt to connect to the network was unsuccessful.

A successful connection to the wireless network may generally indicate that server device 205 was authenticated with the provided Root CA certificate (included in the ANQP element), or a Root CA certificate from a trust store associated with client computing device 215. Also, for example, a successful connection to the wireless network may indicate that the connection is encrypted. However, client computing device 215 may deem server device 205 to be “untrusted”. Also, for example, server device 205 may deem client computing device 215 to be “untrusted”. The term “untrusted” as used herein, may generally refer to a status of a device that has not been sufficiently authenticated. For example, a first device (e.g., client computing device 215) may be untrusted by a second device (e.g., server device 205) if the first device has failed to complete an authentication process required by the second device. Generally speaking, an untrusted first device may have restricted access, or no access, to one or more resources (e.g., access to the internet) offered by the second device.

Upon successfully establishing the initial network connection, client computing device 215 is connected to WAP 210 in an untrusted mode. The wireless network also may not trust client computing device 215 since the temporary username and password are sent in the clear and are available to the public for use. Generally, server device 205 identifies unique clients for each active session by a MAC address associated with the client device. As per the standard in IEEE 802.11, the client device may not modify a MAC address during an active session. Accordingly, server device 205 can support multiple concurrent connections with the same temporary username and password, and securely monitor the state of each of the connected client devices.

Upon establishing the initial network connection, client computing device 215 may be directed to captive portal 250 associated with WAP 210 and/or server device 205. For example, client computing device 215 may have Wi-Fi access but no internet access. Since client computing device 215 is untrusted, server device 205 may support client computing device 215 in one or more modes. For example, client computing device 215 may be captivated behind captive portal 250. The captive portal may include one or more of a payment portal, a registration portal, an identification portal, or a terms and conditions (T&C) portal. For example, for standard Enterprise networks client computing device 215 may be redirected to captive portal 250. Also, for example, client computing device 215 may be captivated behind a terms and conditions (T&C) portal. For Passpoint networks, client computing device 215 may be provided a uniform resource locator (URL) for the T&C as part of the protocol.

In some embodiments, client computing device 215 may automatically detect a type of captive portal 250. In some embodiments, a restricted web browser may be automatically launched by client computing device 215. For example, the web browser may be configured to verify the server certificate of server device 205 using Hypertext Transfer Protocol Secure (HTTPS). Also, for example, the web browser may be configured to verify that the server certificate is signed by a globally trusted Root CA used for web browsing. In some embodiments, upon completion of the verification process, the web browser may be configured to load the content of the portal and display it to the user of client computing device 215.

Generally, the content provided by captive portal 250 may not be specified, and may depend on an operator of the wireless network. For example, the operator may require T&C acceptance, payment, identification, and/or registration. The user may decide whether to trust and engage with the wireless network, similar to any available open public network. In some situations, a user may decide to abort the connection process, and proceed to disconnect from the wireless network.

Accordingly, at 8, when a user decides to continue connecting to the wireless network, the user may complete one or more subscription tasks, such as, for example, providing payment information, registration information, identification information, and/or accept terms and conditions associated with captive portal 250. Although existing protocols enable such user interaction with captive portal 250, the information is generally sent over an unsecured network, thereby exposing the protected data to a potential cyber breach. However, the initial network connection is a secured network, and protected data is encrypted.

At 255, server device 205 may generate subscription data including a profile or a subscription for client computing device 215 to install. In some embodiments, the subscription data may include a trust certificate for client computing device 215. Generally, the subscription data may be based on one or more of a version of a browser application or an operating system (OS) of client computing device 215. For example, server device 205 may detect a web browser and an OS version, and generate an appropriate profile and/or subscription for the client computing device 215 to download and install.

For example, at 9, client computing device 215 may complete the in-band secure access protocol by downloading (and installing and/or saving) a subscription file based on the subscription data from server device 205. In some embodiments, the subscription data may include a unique username and password that may be received in a secure way over the initial network connection. Correspondingly, WAP 210 may complete the in-band secure access protocol by providing the subscription file for download by the client computing device.

At 10, subsequent to the downloading of the subscription file, client computing device 215 may disconnect the initial network connection. Correspondingly, WAP 210 may disconnect the initial network connection subsequent to the downloading of the subscription file by client computing device 215.

In some embodiments, at 11, after disconnecting the initial network connection, client computing device 215 may establish an encrypted and trusted network connection over the wireless network.

Upon a successful completion of the in-band secure access protocol, client computing device 215 may save the subscription data and/or subscription file. Accordingly, at a future time when client computing device 215 is in a vicinity of the same wireless network, at 225, client computing device 215 may be able to determine a match between the saved credentials, and the data included in the ANQP element received from WAP 210. Accordingly, client computing device 215 may, at 4, connect automatically to the wireless network without having to perform additional steps.

Similar to a public network, the in-band secure access protocol may not guarantee a quality of service, or an authentication of an identity of a network provider. The protocol uses TLS and HTTPS during the in-band sign up process. For example, when the web browser is launched to enable the exchange of the subscription data, the URL of the website may be displayed, along with a lock sign indicating HTTPS. This may allow a user to determine if they want to trust the wireless network or not.

### III. Example Client Computing Devices

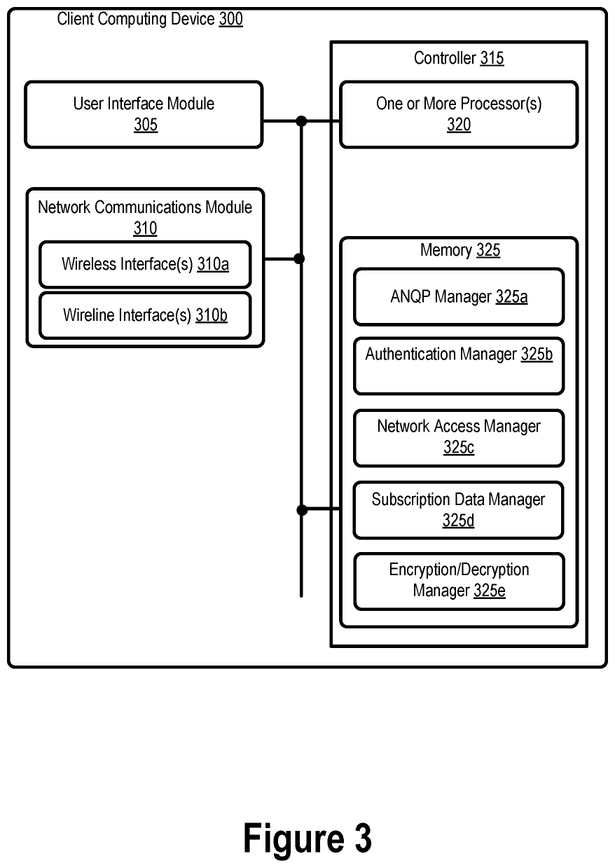

FIG. 3 illustrates an example client computing device 300, in accordance with example embodiments. Client computing device 300 includes user interface module 305, network communications module 310, and controller 315. Controller 315 may include one or more processor(s) 320, and memory 325. In some embodiments, network communications module 310 may include wireless interface(s) 310a, and wireline interface(s) 310b. In some examples, client computing device 300 may take the form of a desktop device, a server device, or a mobile device. In some embodiments, client computing device 300 may share one or aspects with client computing devices 104a-104f of FIG. 1, and/or with client computing device 215 of FIG. 2.

User interface module 305 may be configured to provide output signals to a user and receive input signal from a user by way of one or more screens (including touch screens), cathode ray tubes (CRTs), liquid crystal displays (LCDs), light emitting diodes (LEDs), organic LEDs (OLEDs), displays using digital light processing (DLP) technology, and/or other similar technologies. User interface module 305 may also be configured to generate audible outputs, such as with a speaker, speaker jack, audio output port, audio output device, earphones, and/or other similar devices. User interface module 305 may further be configured with one or more haptic components that can generate haptic outputs, such as vibrations and/or other outputs detectable by touch and/or physical contact with client computing device 300.

In some embodiments, user interface module 305 may be configured to provide a Wi-Fi picker that displays a list of names (e.g., SSIDs) for available networks. In some embodiments, user interface module 305 may be configured to provide a temporary identifier indicative of the wireless network in the Wi-Fi picker, and an associated user interface element to receive the user confirmation. For example, user interface module 305 may be configured to provide a pseudo entry in the Wi-Fi picker that would include a network friendly name (e.g., based on an ANQP response), and a message below the entry that may indicate “Tap to sign-up”. Also, for example, user interface module 305 may be configured to detect user confirmation to join the network. In some embodiments, user interface module 305 may be configured to provide an interactive display of a web browser that facilitates exchange of subscription data.

Network communications module 310 can include one or more wireless interfaces and/or wireline interfaces that are configurable to communicate via a network. Wireless interfaces 310a can include one or more wireless transmitters, receivers, and/or transceivers, such as a Bluetooth™ transceiver, a Zigbee® transceiver, a Wi-Fi™ transceiver, a WiMAX™ transceiver, and/or other similar types of wireless transceivers configurable to communicate via a wireless network. Wireline interfaces 310b can include one or more wireline transmitters, receivers, and/or transceivers, such as an Ethernet transceiver, a Universal Serial Bus (USB) transceiver, or similar transceiver configurable to communicate via a twisted pair wire, a coaxial cable, a fiber-optic link, or a similar physical connection to a wireline network.

In some embodiments, network communications module 310 can be configured to provide reliable, secured, and/or authenticated communications. For each communication described herein, information for facilitating reliable communications (e.g., guaranteed message delivery) can be provided, perhaps as part of a message header and/or footer (e.g., packet/message sequencing information, encapsulation headers and/or footers, size/time information, and transmission verification information such as cyclic redundancy check (CRC) and/or parity check values). Communications can be made secure (e.g., be encoded or encrypted) and/or decrypted/decoded using one or more cryptographic protocols and/or algorithms, such as, but not limited to, Data Encryption Standard (DES), Advanced Encryption Standard (AES), a Rivest-Shamir-Adelman (RSA) algorithm, a Diffie-Hellman algorithm, a secure sockets protocol such as Secure Sockets Layer (SSL) or Transport Layer Security (TLS), and/or Digital Signature Algorithm (DSA). Other cryptographic protocols and/or algorithms can be used as well or in addition to those listed herein to secure (and then decrypt/decode) communications.

Controller 315 may include one or more processor(s) 320 and memory 325. Processor(s) 320 can include one or more general purpose processors and/or one or more special purpose processors (e.g., display driver integrated circuit (DDIC), digital signal processors (DSPs), tensor processing units (TPUs), graphics processing units (GPUs), application specific integrated circuits (ASICs), etc.). Processor(s) 320 may be configured to execute computer-readable instructions that are contained in memory 325 and/or other instructions as described herein.

Memory 325 may include one or more non-transitory computer-readable storage media that can be read and/or accessed by processor(s) 320. The one or more non-transitory computer-readable storage media can include volatile and/or non-volatile storage components, such as optical, magnetic, organic, or other memory or disc storage, which can be integrated in whole or in part with at least one of processor(s) 320. In some examples, memory 325 can be implemented using a single physical device (e.g., one optical, magnetic, organic or other memory or disc storage unit), while in other examples, memory 325 can be implemented using two or more physical devices.

In example embodiments, processor(s) 320 are configured to execute instructions stored in memory 325 to carry out operations.

The operations may include determining, by client computing device 300, that a wireless access point (WAP) supports an in-band secure access protocol to connect to a wireless network hosted by a server. The in-band secure access protocol may include establishing an initial network connection to exchange subscription data to connect to the wireless network.

The operations may also include receiving, by client computing device 300 from the WAP, a temporary login credential and an authentication protocol for the server.

The operations may additionally include utilizing the temporary login credential and the authentication protocol to establish the initial network connection with the WAP.

The operations may further include exchanging the subscription data with the server over the initial network connection.

The operations may also include completing the in-band secure access protocol by downloading, from the WAP and over the initial network connection, a subscription file, wherein the subscription file is based on the subscription data, and wherein the subscription file enables the client computing device to establish an encrypted and trusted network connection over the wireless network.

In some embodiments, the operations may be performed by one or more managers that may be configured to perform the operations. The one or more managers may include access network query protocol (ANQP) manager 325a, authentication manager 325b, network access manager 325c, subscription data manager 325d, and encryption/decryption manager 325e.

ANQP manager 325a may be configured to request an ANQP element from a wireless access point (WAP). ANQP manager 325a may also be configured to extract connection parameters from the ANQP element. In some embodiments, ANQP manager 325a may also be configured to determine that the WAP supports an in-band secure access protocol. Such a determination may be based on the received ANQP element, and/or based on a beacon broadcast by the WAP. Upon a determination that the WAP supports an in-band secure access protocol, in some embodiments, ANQP manager 325a may be configured to request a modified ANQP element that includes information about the in-band secure access protocol.

Authentication manager 325b may be configured to exchange subscription data with a server over an initial network connection. Authentication manager 325b may be configured to authenticate with a provided Root CA certificate (included in the ANQP element), or a Root CA certificate from a trust store associated with client computing device 300 (e.g., stored in memory 325. In some embodiments, authentication manager 325b may be configured to manage interactions of a user with a captive portal. For example, authentication manager 325b may be configured to verify a server certificate of a server device using Hypertext Transfer Protocol Secure (HTTPS). Also, for example, authentication manager 325b may be configured to verify that the server certificate is signed by a globally trusted Root CA used for web browsing. In some embodiments, authentication manager 325b may be configured to perform the preferred server authentication method and phase-2 method as indicated by the ANQP element. For example, authentication manager 325b may be configured to perform the extensible authentication protocol (EAP) with a secure sockets layer (SSL) around diameter type length values (TLVs), and the phase-2 protocol comprising a challenge handshake authentication protocol. In some embodiments, authentication manager 325b may be configured to perform the server authentication protocol comprising an extensible authentication protocol (EAP) with a secure sockets layer (SSL) around the EAP, and the phase-2 protocol comprising a generic token card (GTC).

Network access manager 325c may be configured to manage wireless connections between client computing device 300 and a wireless local area network. Network access manager 325c may be configured to discover and determine the capabilities of wireless access points, send an authentication request for wireless local area network access, identify and select a wireless local area network to access, and associate with a wireless access point to access the wireless local area network. In some embodiments, network access manager 325c may be configured to utilize data in an ANQP element to establish an initial network connection. In some embodiments, network access manager 325c may be configured to complete the in-band secure access protocol by establishing, based on subscription data, an encrypted and trusted network connection over the wireless network.

Network access manager 325c may be configured to generate an authentication request, including, for example, user authentication credentials. For example, network access manager 325c may generate, based on the received ANQP element, a temporary extensible authentication protocol (EAP) configuration comprising: (i) a Service Set Identifier (SSID) of the wireless access point, (ii) the authentication protocol, (iii) a server certificate, (iv) a server domain name, and (v) the temporary login credential. In some embodiments, network access manager 325c may be configured to utilize the temporary EAP configuration to establish the initial network connection.

Network access manager 325c may be configured to identify and/or select one or more wireless local area networks that a user of client computing device 300 is authorized to access. In some embodiments, network access manager 325c may be configured to receive a list of one or more wireless local area networks that the user is authorized to access from a server. In some embodiments, network access manager 325c may be configured to select a wireless local area network within the list to connect to, based on an order of the list. In some embodiment, network access manager 325c may be configured to associate client computing device 300 with a wireless access point to access a wireless local area network that the user is authorized to access. In some embodiment, network access manager 325c may be configured to provide, using user interface module 305, a temporary identifier indicative of the wireless network, and an associated user interface element to receive a user confirmation to join the wireless network. In some embodiments, network access manager 325c may be configured to automatically detect a type of captive portal (e.g., a payment portal, a registration portal, an identification portal, a terms and conditions (T&C) portal, and so forth).

Subscription data manager 325d may be configured to store subscription data and/or login credentials. Also, for example, subscription data manager 325d may be configured to determine whether the data in the ANQP element matches one or more saved credentials at client computing device 300. In some embodiments, subscription data manager 325d may be configured to automatically launch a restricted web browser to enable exchange of subscription data. As another example, upon successful completion of an in-band secure access protocol, subscription data manager 325d may be configured to store the subscription data associated with the wireless network. In some embodiments, subscription data manager 325d may be configured to securely store protected data such as a name, financial information, telephone number, address, and so forth, and/or to automatically fill-in an online form with such information, based on an affirmative user confirmation of such automatic fill-in activity.

Encryption/decryption manager 325e may be configured to perform encryption and/or decryption of transmissions to/from a server (e.g., server device 108, server device 110, etc. of FIG. 1). Encryption/decryption module 325e may be configured to encrypt the authentication request, for example, using one or more cryptographic keys stored in memory 325. Client computing device 300 may provide the encrypted authentication request to the server, e.g., via wireless access point and network (e.g., WAP 102a, WAP 202b, etc. and network 106 of FIG. 1).

In some embodiments, client computing device 300 may be a second wireless access point that arrives at a local area network served by a first wireless access point.

### IV. Example Wireless Access Points

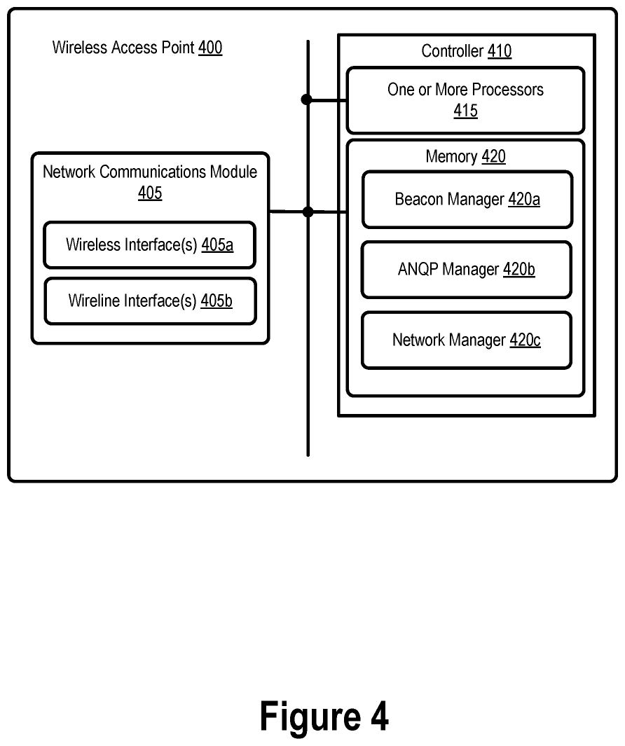

FIG. 4 illustrates an example wireless access point 400, in accordance with example embodiments. WAP 400 includes network communications module 405, and controller 410. Controller 410 may include one or more processor(s) 415, and memory 420. In some embodiments, network communications module 405 may include wireless interface(s) 405a, and wireline interface(s) 405b. In some embodiments, WAP 400 may share one or aspects with WAP 102a, WAP 102b, of FIG. 1, and/or with WAP 210 of FIG. 2.

Network communications module 405 can include one or more wireless interfaces and/or wireline interfaces that are configurable to communicate via a network. WAP 400 may establish a network connection with a client computing device (e.g., client computing devices 104a-104f of FIG. 1, client computing device 215 of FIG. 2) via one or more wireless interface(s) 405a. WAP 400 may establish a network connection with a network (e.g., network 106 of FIG. 1) via one or more network interfaces.

Wireless interfaces 405a can include one or more wireless transmitters, receivers, and/or transceivers, such as a Bluetooth™ transceiver, a Zigbee® transceiver, a Wi-Fi™ transceiver, a WiMAX™ transceiver, and/or other similar types of wireless transceivers configurable to communicate via a wireless network. Wireline interfaces 405b can include one or more wireline transmitters, receivers, and/or transceivers, such as an Ethernet transceiver, a Universal Serial Bus (USB) transceiver, or similar transceiver configurable to communicate via a twisted pair wire, a coaxial cable, a fiber-optic link, or a similar physical connection to a wireline network.

In some embodiments, network communications module 405 can be configured to provide reliable, secured, and/or authenticated communications. For each communication described herein, information for facilitating reliable communications (e.g., guaranteed message delivery) can be provided, perhaps as part of a message header and/or footer (e.g., packet/message sequencing information, encapsulation headers and/or footers, size/time information, and transmission verification information such as cyclic redundancy check (CRC) and/or parity check values). Communications can be made secure (e.g., be encoded or encrypted) and/or decrypted/decoded using one or more cryptographic protocols and/or algorithms, such as, but not limited to, Data Encryption Standard (DES), Advanced Encryption Standard (AES), a Rivest-Shamir-Adelman (RSA) algorithm, a Diffie-Hellman algorithm, a secure sockets protocol such as Secure Sockets Layer (SSL) or Transport Layer Security (TLS), and/or Digital Signature Algorithm (DSA). Other cryptographic protocols and/or algorithms can be used as well or in addition to those listed herein to secure (and then decrypt/decode) communications.

Controller 410 may include one or more processor(s) 415 and memory 420. Processor(s) 415 can include one or more general purpose processors and/or one or more special purpose processors (e.g., display driver integrated circuit (DDIC), digital signal processors (DSPs), tensor processing units (TPUs), graphics processing units (GPUs), application specific integrated circuits (ASICs), etc.). Processor(s) 415 may be configured to execute computer-readable instructions that are contained in memory 420 and/or other instructions as described herein.

Memory 420 may include one or more non-transitory computer-readable storage media that can be read and/or accessed by processor(s) 415. The one or more non-transitory computer-readable storage media can include volatile and/or non-volatile storage components, such as optical, magnetic, organic, or other memory or disc storage, which can be integrated in whole or in part with at least one of processor(s) 415. In some examples, memory 420 can be implemented using a single physical device (e.g., one optical, magnetic, organic or other memory or disc storage unit), while in other examples, memory 420 can be implemented using two or more physical devices.

In example embodiments, processor(s) 415 are configured to execute instructions stored in memory 420 to carry out operations.

The operations may include broadcasting, by WAP 400, that WAP 400 supports an in-band secure access protocol to connect to a wireless network hosted by a server. The in-band secure access protocol may include establishing an initial network connection to exchange subscription data to connect to the wireless network.

The operations may further include sending, by WAP 400 to a client computing device, a temporary login credential and an authentication protocol for the server.

The operations may also include enabling, by WAP 400, the client computing device to utilize the temporary login credential and the authentication protocol to establish the initial network connection with the WAP.

The operations may additionally include enabling the exchange of the subscription data between the client computing device and the server over the initial network connection.

The operations may also include completing the in-band secure access protocol by providing, over the initial network connection, a subscription file for download by the client computing device, wherein the subscription file is based on the subscription data, and wherein the subscription file enables the client computing device to establish an encrypted and trusted network connection over the wireless network.

In some embodiments, the operations may be performed by one or more managers that may be configured to perform the operations. The one or more managers may include beacon manager 420a, ANQP manager 420b, and network manager 420c.

Beacon manager 420a may be configured to broadcast an advertisement, such as a beacon, about the capabilities of WAP 400. For example, beacon manager 420a may be configured to broadcast that WAP 400 supports Enterprise or Passpoint security. In some embodiments, an additional bit may be added to make such a broadcast. Also, for example, beacon manager 420a may be configured to broadcast that WAP 400 supports an in-band secure access protocol to connect to a wireless network hosted by a server.

ANQP manager 420b may be configured to receive a request for an ANQP element from a client computing device, and may be configured to send an ANQP element in response to the request. In existing sign-up protocols, an ANQP is utilized to enable a client computing device to query WAP 400 prior to establishing a connection. Responses to such an ANQP query may enable the client computing device to decide whether to connect to WAP 400 or not. As described previously, the ANQP protocol is generally used to sign up to existing networks. However, the existing ANQP element provided by WAP 400 would need to be additionally configured to include information that can enable in-band secure access.

In some embodiments, ANQP manager 420b may be configured to provide a domain name of a server device associated with a wireless network supported by WAP 400. In some embodiments, ANQP manager 420b may be configured to provide a root certificate authority (Root CA certificate) configured to sign a server certificate, or a hash of a globally trusted Root CA certificate configured for web browsing. Also, for example, ANQP manager 420b may be configured to provide temporary login credentials (e.g., a temporary username and password) to the client computing device.

Network manager 420c may be configured to grant access to a wireless local area network in response to an association request from a client computing device. Network manager 420c may be configured to associate with client computing devices to access wireless local area networks based on authentication of user account credentials. In some embodiments, network manager 420c may be configured to send a notification of the association of a client computing device to the server device.

Network manager 420c may be configured to generate a secure pathway within WAP 400, such as a secure connection between a client computing device and a server. In some embodiments, network manager 420c may be configured to encapsulate transmissions between WAP 400 and a server in a tunnel, such as a TLS tunnel, EAP-TLS based tunnel, a tunnel on top of a generic advertisement service (GAS) and ANQP. In some embodiments, network manager 420c may be configured to establish a secure connection using an authentication protocol that includes a server authentication protocol and a phase-2 protocol. For example, the server authentication protocol may include an EAP with an SSL around diameter TLVs, and the phase-2 protocol may include a challenge handshake authentication protocol. As another example, the server authentication protocol may include an EAP with an SSL around the EAP, and the phase-2 protocol may include a GTC. In some embodiments, network manager 420c may be configured to transport user authentication credentials and/or subscription data to a server via the tunnel.

As described herein, network manager 420c may be configured to enable a client computing device to utilize a temporary login credential and the authentication protocol to establish an initial network connection with the server. As indicated, the initial network connection may be a secured but untrusted connection. Also, for example, upon completion of the in-bound secure access protocol, network manager 420c may be configured to enable, and maintain, an encrypted and trusted network connection over the wireless network.

In some embodiments, network manager 420c may be configured to enable an exchange of a security token between a server and a client computing device via the secure pathway. In some embodiments, network manager 420c may be configured to enable an exchange of an encryption key and/or encrypted content between a server and a client computing device via the secure pathway.

Although not illustrated, WAP 400 may include a routing table to manage one or more connections between a plurality of servers and client computing devices. For example, the routing table may list the routes to particular network destinations, metrics (e.g., distances) associated with those routes, latencies for network packets traveling via such routes, and so forth.

### V. Example Methods

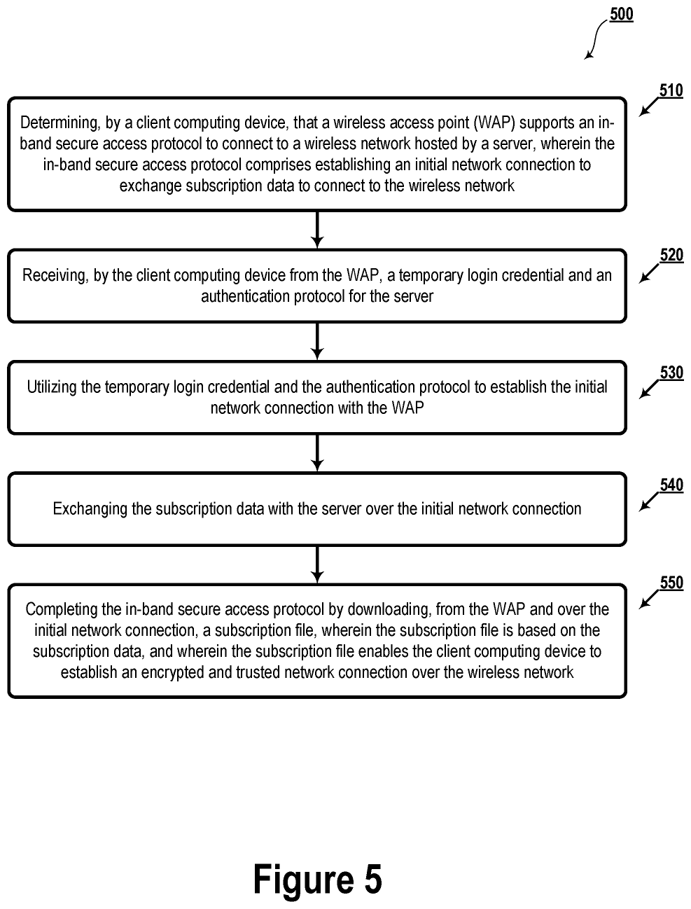

FIG. 5 illustrates a method 500, in accordance with example embodiments. Method 500 may include various blocks or steps. The blocks or steps may be carried out individually or in combination. The blocks or steps may be carried out in any order and/or in series or in parallel. Further, blocks or steps may be omitted or added to method 500.

The blocks of method 500 may be carried out by various elements of client computing devices 104a-104f of FIG. 1, client computing device 215 of FIG. 2, and/or client computing device 300 of FIG. 3, as illustrated and described in reference to the respective figures.

Block 510 includes determining, by a client computing device, that a wireless access point (WAP) supports an in-band secure access protocol to connect to a wireless network hosted by a server, wherein the in-band secure access protocol comprises establishing an initial network connection to exchange subscription data to connect to the wireless network.

Block 520 includes receiving, by the client computing device from the WAP, a temporary login credential and an authentication protocol for the server.

Block 530 includes utilizing the temporary login credential and the authentication protocol to establish the initial network connection with the WAP.

Block 540 includes exchanging the subscription data with the server over the initial network connection.

Block 550 includes completing the in-band secure access protocol by downloading, from the WAP and over the initial network connection, a subscription file, wherein the subscription file is based on the subscription data, and wherein the subscription file enables the client computing device to establish an encrypted and trusted network connection over the wireless network.

In some embodiments, the completion of the in-band secure access protocol further involves, subsequent to the downloading of the subscription file, disconnecting the initial network connection, and establishing, based on the subscription file, the encrypted and trusted network connection over the wireless network.

In some embodiments, the determining that the WAP supports the in-band secure access protocol further includes detecting a broadcast of a beacon by the WAP, wherein the beacon comprises a capability bit indicating the support for the in-band secure access protocol.

Some embodiments include sending, to the WAP, a request for an access network query protocol (ANQP) element. The receiving of the temporary login credential and the authentication protocol includes receiving the ANQP element in response to the request for the ANQP element.

In some embodiments, the ANQP element further includes one of a public key certificate issued by a root certificate authority (Root CA certificate) configured to sign a server certificate, or a hash of a globally trusted Root CA certificate configured for web browsing.

In some embodiments, the determining that the WAP supports the in-band secure access protocol may be based on the received ANQP element.

In some embodiments, the determining that the WAP supports the in-band secure access protocol may be performed subsequent to determining that one or more authentication credentials stored at the client computing device do not match the received ANQP element.

In some embodiments, the utilizing of the temporary login credential and the authentication protocol for the server to establish the initial network connection further includes generating, by the client computing device and based on the received ANQP element, a temporary extensible authentication protocol (EAP) configuration comprising: (i) a Service Set Identifier (SSID) for the wireless access point, (ii) the authentication protocol, (iii) a server certificate, (iv) a server domain name, and (v) the temporary login credential. Such embodiments also include utilizing the temporary EAP configuration to establish the initial network connection.

Some embodiments involve requesting, by the client computing device, user confirmation to connect to the wireless network. The establishing of the initial network connection may be performed upon receiving the user confirmation. In some embodiments, the requesting of the user confirmation further includes providing, by a display of the client computing device, a temporary identifier indicative of the wireless network, and an associated user interface element to receive the user confirmation.

In some embodiments, subsequent to the establishing of the initial network connection, the client computing device may be redirected to a captive portal associated with the server. The captive portal may include one or more of a payment portal, a registration portal, an identification portal, or a terms and conditions (T&C) portal.

In some embodiments, the exchanging of the subscription data further includes detecting, by the client computing device, a type of the captive portal. Such embodiments also include verifying, over the initial network connection, a server certificate associated with the server. Such embodiments further include launching, by a browser application, a limited web browser that loads a content of the captive portal. Such embodiments additionally include providing, by the client computing device, the content of the captive portal, wherein the content includes one or more subscription tasks to be completed by a user of the client computing device.

In some embodiments, the subscription file includes a trust certificate. Such embodiments may include receiving an indication of user completion of the one or more subscription tasks. Such embodiments also include, in response to the user completion of the one or more subscription tasks, downloading, from the server, the trust certificate for the client computing device based on one or more of a version of a browser application or an operating system of the client computing device. Such embodiments additionally include installing the downloaded trust certificate onto the client computing device. The encrypted and trusted network connection may be based on the downloaded trust certificate. In some embodiments, the trust certificate may include one of a profile trust certificate or a subscription trust certificate.

In some embodiments, the authentication protocol may include a server authentication protocol and a phase-2 protocol.

In some embodiments, the server authentication protocol may include an extensible authentication protocol (EAP) with a secure sockets layer (SSL) around diameter type length values (TLVs), and the phase-2 protocol comprises a challenge handshake authentication protocol.

In some embodiments, the server authentication protocol may include an extensible authentication protocol (EAP) with a secure sockets layer (SSL) around the EAP, and the phase-2 protocol comprises a generic token card (GTC).

In some embodiments, the wireless network may be one of an Enterprise or a Passpoint network.

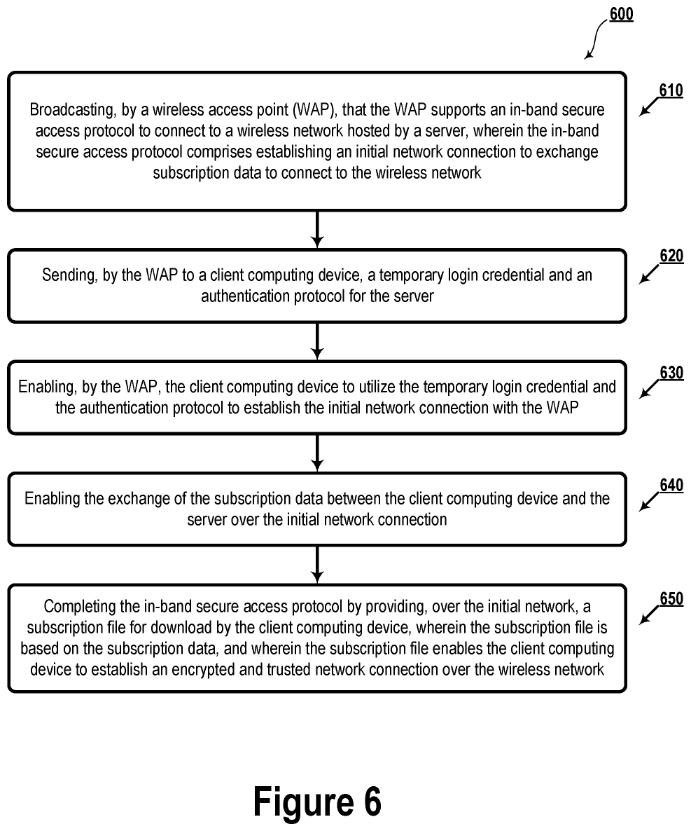

FIG. 6 illustrates a method 600, in accordance with example embodiments. Method 600 may include various blocks or steps. The blocks or steps may be carried out individually or in combination. The blocks or steps may be carried out in any order and/or in series or in parallel. Further, blocks or steps may be omitted or added to method 600.

The blocks of method 600 may be carried out by various elements of WAP 102a, WAP 102b, of FIG. 1, WAP 210 of FIG. 2, and/or WAP 400 of FIG. 4, as illustrated and described in reference to the respective figures.

Block 610 includes broadcasting, by a wireless access point (WAP), that the WAP supports an in-band secure access protocol to connect to a wireless network hosted by a server, wherein the in-band secure access protocol comprises establishing an initial network connection to exchange subscription data to connect to the wireless network.

Block 620 includes sending, by the WAP to a client computing device, a temporary login credential and an authentication protocol for the server.

Block 630 includes enabling, by the WAP, the client computing device to utilize the temporary login credential and the authentication protocol to establish the initial network connection with the WAP.

Block 640 includes enabling the exchange of the subscription data between the client computing device and the server over the initial network connection.

Block 650 includes completing the in-band secure access protocol by providing, over the initial network connection, a subscription file for download by the client computing device, wherein the subscription file is based on the subscription data, and wherein the subscription file enables the client computing device to establish an encrypted and trusted network connection over the wireless network.

In some embodiments, the broadcasting includes broadcasting a beacon comprising a capability bit indicating the support for the in-band secure access protocol.

Some embodiments include receiving, from the client computing device, a request for an access network query protocol (ANQP) element. The sending of the temporary login credential and the authentication protocol may include sending the ANQP element in response to the request for the ANQP element.

In some embodiments, the ANQP element further includes one of a public key certificate issued by a root certificate authority (Root CA certificate) configured to sign a server certificate, or a hash of a globally trusted Root CA certificate configured for web browsing.

In some embodiments, the enabling of the client computing device to utilize the temporary login credential and the authentication protocol may be based on a temporary extensible authentication protocol (EAP) configuration generated by the client computing device, wherein the temporary EAP configuration comprises: (i) a Service Set Identifier (SSID) of the wireless access point, (ii) the authentication protocol, (iii) a server certificate, (iv) a server domain name, and (v) the temporary login credential.

In some embodiments, the enabling of the exchange of the subscription data further includes, subsequent to the establishing of the initial network connection, redirecting the client computing device to a captive portal associated with the server.

In some embodiments, the subscription file includes a trust certificate. In such embodiments, the completion of the in-band secure access protocol further includes receiving, by the WAP, an indication that one or more subscription tasks at the captive portal have been completed by a user of the client computing device. Such embodiments include providing, by the WAP and to the client computing device and over the initial network connection, the trust certificate for download and installation by the client computing device, the trust certificate having been generated by the server. The trust certificate may be based on one or more of a version of a browser application or an operating system of the client computing device. Such embodiments also include receiving, by the WAP and over the initial network connection, an indication that the client computing device has been authenticated by the server based on the trust certificate. Such embodiments additionally include enabling the establishing of the encrypted and trusted network connection over the wireless network.

In some embodiments, the trust certificate may include one of a profile trust certificate or a subscription trust certificate.

In some embodiments, the authentication protocol may include a server authentication protocol and a phase-2 protocol.

In some embodiments, the server authentication protocol may include an extensible authentication protocol (EAP) with a secure sockets layer (SSL) around diameter type length values (TLVs), and the phase-2 protocol comprises a challenge handshake authentication protocol.

In some embodiments, the server authentication protocol may include an extensible authentication protocol (EAP) with a secure sockets layer (SSL) around the EAP, and the phase-2 protocol comprises a generic token card (GTC).

The particular arrangements shown in the Figures should not be viewed as limiting. It should be understood that other embodiments may include more or less of each element shown in a given Figure. Further, some of the illustrated elements may be combined or omitted. Yet further, an illustrative embodiment may include elements that are not illustrated in the Figures.

A step or block that represents a processing of information can correspond to circuitry that can be configured to perform the specific logical functions of a herein-described method or technique. Alternatively or additionally, a step or block that represents a processing of information can correspond to a module, a segment, or a portion of program code (including related data). The program code can include one or more instructions executable by a processor for implementing specific logical functions or actions in the method or technique. The program code and/or related data can be stored on any type of computer readable medium such as a storage device including a disk, hard drive, or other storage medium.

The computer readable medium can also include non-transitory computer readable media such as computer-readable media that store data for short periods of time like register memory, processor cache, and random access memory (RAM). The computer readable media can also include non-transitory computer readable media that store program code and/or data for longer periods. Thus, the computer readable media may include secondary or persistent long-term storage, like read only memory (ROM), optical or magnetic disks, compact disc read only memory (CD-ROM), for example. The computer readable media can also be any other volatile or non-volatile storage systems. A computer readable medium can be considered a computer readable storage medium, for example, or a tangible storage device.

While various examples and embodiments have been disclosed, other examples and embodiments will be apparent to those skilled in the art. The various disclosed examples and embodiments are for purposes of illustration and are not intended to be limiting, with the true scope being indicated by the following claims.

1. A computer-implemented method, comprising:
determining, by a client computing device, that a wireless access point (WAP) supports an in-band secure access protocol to connect to a wireless network hosted by a server, wherein the in-band secure access protocol comprises establishing an initial network connection to exchange subscription data to connect to the wireless network;
receiving, by the client computing device from the WAP, a temporary login credential and an authentication protocol for the server;
utilizing the temporary login credential and the authentication protocol to establish the initial network connection with the WAP;
exchanging the subscription data with the server over the initial network connection; and
completing the in-band secure access protocol by downloading, from the WAP and over the initial network connection, a subscription file, wherein the subscription file is based on the subscription data, and wherein the subscription file enables the client computing device to establish an encrypted and trusted network connection over the wireless network.

2. The computer-implemented method of claim 1, further comprising:
subsequent to the downloading of the subscription file, disconnecting the initial network connection; and
establishing, based on the subscription file, the encrypted and trusted network connection.

3. The computer-implemented method of claim 1, wherein the determining that the WAP supports the in-band secure access protocol further comprises:
detecting a broadcast of a beacon by the WAP, wherein the beacon comprises a capability bit indicating that the WAP supports the in-band secure access protocol.

4. The computer-implemented method of claim 1, further comprising:
sending, to the WAP, a request for an access network query protocol (ANQP) element, and
wherein the receiving of the temporary login credential and the authentication protocol comprises receiving the ANQP element in response to the request for the ANQP element.

5. The computer-implemented method of claim 4, wherein the ANQP element further comprises one of a public key certificate issued by a root certificate authority (Root CA certificate) configured to sign a server certificate, or a hash of a globally trusted Root CA certificate configured for web browsing.

6. The computer-implemented method of claim 4, wherein the determining that the WAP supports the in-band secure access protocol is based on the received ANQP element.

7. The computer-implemented method of claim 6, wherein the determining that the WAP supports the in-band secure access protocol is performed subsequent to determining that one or more authentication credentials stored at the client computing device do not match the received ANQP element.

8. The computer-implemented method of claim 4, wherein the utilizing of the temporary login credential and the authentication protocol for the server to establish the initial network connection further comprises:
generating, by the client computing device and based on the received ANQP element, a temporary extensible authentication protocol (EAP) configuration comprising: (i) a Service Set Identifier (SSID) for the wireless access point, (ii) the authentication protocol, (iii) a server certificate, (iv) a server domain name, and (v) the temporary login credential; and
utilizing the temporary EAP configuration to establish the initial network connection.

9. The computer-implemented method of claim 1, further comprising:
requesting, by the client computing device, user confirmation to connect to the wireless network, and
wherein the establishing of the initial network connection is performed upon receiving the user confirmation.

10. The computer-implemented method of claim 9, wherein the requesting of the user confirmation further comprises:
providing, by a display of the client computing device, a temporary identifier indicative of the wireless network, and an associated user interface element to receive the user confirmation.

11. The computer-implemented method of claim 1, wherein subsequent to the establishing of the initial network connection, the client computing device is redirected to a captive portal associated with the server.

12. The computer-implemented method of claim 11, wherein the captive portal comprises one or more of a payment portal, a registration portal, an identification portal, or a terms and conditions (T&C) portal.

13. The computer-implemented method of claim 11, wherein the exchanging of the subscription data further comprises:
detecting, by the client computing device, a type of the captive portal;
verifying, over the initial network connection, a server certificate associated with the server;
launching, by a browser application, a limited web browser that loads a content of the captive portal; and
providing, by the client computing device, the content of the captive portal, wherein the content comprises one or more subscription tasks to be completed by a user of the client computing device.

14. The computer-implemented method of claim 13, wherein the subscription file comprises a trust certificate, and the method further comprises:
receiving an indication of user completion of the one or more subscription tasks;
in response to the user completion of the one or more subscription tasks, downloading, from the server, the trust certificate for the client computing device based on one or more of a version of a browser application or an operating system of the client computing device; and
installing the downloaded trust certificate onto the client computing device, and
wherein the encrypted and trusted network connection is based on the downloaded trust certificate.

15. The computer-implemented method of claim 14, wherein the trust certificate comprises one of a profile trust certificate or a subscription trust certificate.

16. The computer-implemented method of claim 1, wherein the authentication protocol comprises a server authentication protocol and a phase-2 protocol.

17. The computer-implemented method of claim 16, wherein the server authentication protocol comprises an extensible authentication protocol (EAP) with a secure sockets layer (SSL) around diameter type length values (TLVs), and the phase-2 protocol comprises a challenge handshake authentication protocol.

18. The computer-implemented method of claim 16, wherein the server authentication protocol comprises an extensible authentication protocol (EAP) with a secure sockets layer (SSL) around the EAP, and the phase-2 protocol comprises a generic token card (GTC).

19. The computer-implemented method of claim 1, wherein the wireless network is one of an Enterprise or a Passpoint network.

20. A computer-implemented method, comprising:
broadcasting, by a wireless access point (WAP), that the WAP supports an in-band secure access protocol to connect to a wireless network hosted by a server, wherein the in-band secure access protocol comprises establishing an initial network connection to exchange subscription data to connect to the wireless network;
sending, by the WAP to a client computing device, a temporary login credential and an authentication protocol for the server;
enabling, by the WAP, the client computing device to utilize the temporary login credential and the authentication protocol to establish the initial network connection with the WAP;
enabling the exchange of the subscription data between the client computing device and the server over the initial network connection; and
completing the in-band secure access protocol by providing, over the initial network connection, a subscription file for download by the client computing device, wherein the subscription file is based on the subscription data, and wherein the subscription file enables the client computing device to establish an encrypted and trusted network connection over the wireless network.

21. The computer-implemented method of claim 20, wherein the broadcasting comprises broadcasting a beacon comprising a capability bit indicating that the WAP supports the in-band secure access protocol.

22. The computer-implemented method of claim 20, further comprising:
receiving, from the client computing device, a request for an access network query protocol (ANQP) element, and
wherein the sending of the temporary login credential and the authentication protocol comprises sending the ANQP element in response to the request for the ANQP element.

23. The computer-implemented method of claim 22, wherein the ANQP element further comprises one of a public key certificate issued by a root certificate authority (Root CA certificate) configured to sign a server certificate, or a hash of a globally trusted Root CA certificate configured for web browsing.

24. The computer-implemented method of claim 20, wherein the enabling of the client computing device to utilize the temporary login credential and the authentication protocol is based on a temporary extensible authentication protocol (EAP) configuration generated by the client computing device, wherein the temporary EAP configuration comprises: (i) a Service Set Identifier (SSID) for the wireless access point, (ii) the authentication protocol, (iii) a server certificate, (iv) a server domain name, and (v) the temporary login credential.

25. The computer-implemented method of claim 20, wherein the enabling of the exchange of the subscription data further comprises:
subsequent to the establishing of the initial network connection, redirecting the client computing device to a captive portal associated with the server.

26. The computer-implemented method of claim 25, wherein the subscription file comprises a trust certificate, and wherein the completing of the in-band secure access protocol further comprises:
receiving, by the WAP, an indication that one or more subscription tasks at the captive portal have been completed by a user of the client computing device;
providing, by the WAP and to the client computing device and over the initial network connection, the trust certificate for download and installation by the client computing device, the trust certificate having been generated by the server, wherein the trust certificate is based on one or more of a version of a browser application or an operating system of the client computing device;
receiving, by the WAP and over the initial network connection, an indication that the client computing device has been authenticated by the server based on the trust certificate; and
enabling the establishing of the encrypted and trusted network connection over the wireless network.

27. The computer-implemented method of claim 26, wherein the trust certificate comprises one of a profile trust certificate or a subscription trust certificate.

28. The computer-implemented method of claim 20, wherein the authentication protocol comprises a server authentication protocol and a phase-2 protocol.

29. The computer-implemented method of claim 28, wherein the server authentication protocol comprises an extensible authentication protocol (EAP) with a secure sockets layer (SSL) around diameter type length values (TLVs), and the phase-2 protocol comprises a challenge handshake authentication protocol.

30. The computer-implemented method of claim 28, wherein the server authentication protocol comprises an extensible authentication protocol (EAP) with a secure sockets layer (SSL) around the EAP, and the phase-2 protocol comprises a generic token card (GTC).

31. A system, comprising:
a wireless access point (WAP) configured to broadcast that the WAP supports an in-band secure access protocol to connect to a wireless network hosted by a server, wherein the in-band secure access protocol comprises establishing an initial network connection to exchange subscription data to connect to the wireless network;
a client computing device comprising one or more processors and data storage, wherein the data storage has stored thereon computer-executable instructions that, when executed by the one or more processors, cause the client computing device to perform operations comprising:
determining, based on the broadcast, that the WAP supports the in-band secure access protocol;
receiving, from the WAP, a temporary login credential and an authentication protocol for the server;
utilizing the temporary login credential and the authentication protocol to establish the initial network connection with the WAP;
exchanging the subscription data with the server over the initial network connection; and
completing the in-band secure access protocol by downloading, from the WAP and over the initial network connection, a subscription file, wherein the subscription file is based on the subscription data, and wherein the subscription file enables the client computing device to establish an encrypted and trusted network connection over the wireless network.
